(19) United States
(12) Patent Application Publication
(10) Pub. No.: US 2007/0240986 A1
(43) Pub. Date: Oct. 18, 2007

(54) Microfluidic Device with Minimized Ohmic Resistance

(75) Inventors: Frederic Reymond, Lutry (CH); Joel Stephane Rossier, Vionnaz (CH); Patrick Morier, Blonay (CH)

Correspondence Address: HOWSON AND HOWSON, SUITE 210, 501 OFFICE CENTER DRIVE, FT WASHINGTON, PA, 19034, US

(73) Assignees: DIAGNOSWISS S.A., Monthey (CH); BIOMERIEUX S.A., Marcy-l'Etoile (FR)

(21) Appl. No.: 11/718,774

(22) PCT Filed: Nov. 11, 2005
(86) PCT No.: PCT/EP05/12112

§ 371 Date: May 7, 2007

Related U.S. Application Data
(60) Provisional application No. 60/627,055, filed on Nov. 12, 2004.

(51) Int. Cl. G01N 27/26; B23P 15/00

(52) U.S. Cl. 204/412; 29/746

(57) ABSTRACT

An electrochemical microfluidic device has one or a plurality of microstructures, such as a microchannel, in which an electrically conductive means is integrated to reduce the ohmic resistance within the microstructure and hence to improve electrochemical measurements particularly when large current densities are involved. The electrically conductive means can be connected as a counter-electrode and can be used to re-generate the product of the reaction occurring at the working electrode. A method of fabricating electrochemical microfluidic devices comprising such an electrically conductive means is also disclosed. The invention may particularly be used in all electrochemical sensor applications where detection is performed in small volumes.

### BACKGROUND TO THE INVENTION

Miniaturisation of analytical devices has become a trend in analytical chemistry for two main reasons: reducing the time required for single analyses and reducing the size of the sample/waste. Many developments have been shown over the last years in the fabrication of microfluidic device and their use for developing assays.

One bottleneck of miniaturisation of analytical systems is to ensure a low limit of detection of the low number of molecules present in the small volume of the microfluidic device. Different detection means including optical, mass spectrometry or electrochemical detection have been implemented with success to detect rather large concentrations of analyte. For example, many microsystems exist for the detection of glucose in microfluidic devices, for example the system developed by Therasense and which allows one to perform a coulometric detection in only 0.3 μL of capillary blood. Detecting low concentrations while ensuring large dynamic ranges necessitates the optimisation of the geometry of the microfluidic device as well as the method of detection. This invention aims at a specific method and related device that enable the detection of lower concentration of redox active molecules, particularly applied to enzyme and immunological assays (immunoassays),

### SUMMARY OF THE INVENTION

The present invention relates to an electrochemical microfluidic device and method to optimise electrochemical detection in a microstructure (and, preferably, a microchannel or a network of microchannels). The essential feature of the device is to minimise the ohmic resistance of the microstructure(s). Minimisation of the ohmic resistance (or even of the impedance) of a microstructure allows one to improve the electrochemical detection and notably amperometric measurements since the over-potential to apply to compensate for the ohmic resistance can also be minimised, which allows an improved quality of the electrical signal.

One aim of the invention is thus to optimise electrochemical detection in a microfluidic device. Electrochemical detection in microfluidic devices has already been shown as an attractive solution for the detection of redox-active molecules in small volumes. This technique can for instance be used as a detection means after separation or for enzyme or immunoassay analyses. One of the constraints of microfluidic systems is that the typical dimensions of the microstructures are quite unfavourable against the conduction of current. Indeed, when for instance a microstructure consists of a tubular capillary having typical dimensions of one or few centimeters in length (L) and few tens of micrometer in diameter (d), the ohmic resistance (R) is large even if the resistivity of the solution (ρ) is rather low, as expressed by the ohmic law of equation 1:
R=ρL/A Equation 1
where A is the cross-section area of the tube capillary with A=πd²/4.

As an example, when the capillary radius is 20 μm and the length of the capillary to transport the solution is 1 cm, the factor L/A is equal to 8×10⁶ cm⁻¹. With a solution of 100 mM phosphate, the resistance along such a microchannel would already be 10⁶Ω, so that only small current densities could be transported along this channel.

The large resistance present in microfluidic systems is an important drawback for electrochemical applications. Indeed, this resistance may distort the responses, necessitate feed-back voltage to compensate for the drop due to the ohmic resistance or even prevent large signals to be measured accurately. For such electrochemical applications, and in particular, for electrochemical biosensors, it would thus be of great advantage to have microfluidic systems with reduced resistance.

In our invention, the microstructure dimensions are in the same order of magnitude as those given in the above example (channel length in the centimeter range and channel diameter of a few tens of μm). However, an electrically conductive means is positioned in a portion of the microstructure or along the entire microchannel such as to conduct the current from one point of the channel to another one. In this case, the current is no more transported only by the ionic current through the channel, but it can also be transported through the electrically conductive means.

Experiments made with and without conductive means in microstructures having a microchannel of dimensions similar to those mentioned above show that the current intensity that can be passed without ohmic resistance (or “iR drop”) is larger in the case where the microstructure comprises an electrically conductive means. In some cases, the electrically conductive means can be connected as a counter-electrode such as to enable counter reaction to take place inside the channel and hence regeneration of the product of the reaction taking place at the working electrode.

As will be shown in further detail below, it has also been put into evidence that excellent electrochemical responses can be obtained even when the electrically conductive means is not connected and hence is not part of the ensemble of electrodes serving for the detection (hereinafter also referred to as “electrode system”). For the sake of clarity, a 2-electrode system comprises only working and pseudo-reference electrodes and a 3-electrode system comprises working, counter and reference electrodes. In the invention, the microfluidic device comprises an electrically conductive means which may be present in addition to the 2-electrode or 3-electrode ensemble, and this electrically conductive means is then not connected to any of these electrodes. In such a case, when the microfluidic device is filled with a solution, a contact will be created between the ensemble of electrodes and the electrically conducting means, which becomes thus part of the global electrical circuit. In the invention, the electrically conductive means may itself constitute a counter-electrode or a pseudo-reference electrode and then be part of the electrode ensemble. In both configurations, the electrically conductive means shall be adapted to provide an extremely low-resistance path for the current, so that the global resistance of the microstructure is minimised, even for a microstructure of very small cross-section. As will be further described below, it appears that the resistance of the microstructure is thus reduced even when the electrically conducting means is not directly connected.

This phenomenon is very interesting to prevent perturbation of the electrochemical detection signal in a microsystem, and it is likely to be explained by the fact that the presence of an electrically conductive means along the microstructure creates a system that can be schematically represented by two resistances in parallel (one large resistance, Rm, resulting from the small dimension of the microstructure and from the relatively high resistance of the solution, and one very low resistance, Rc, due to the extremely low resistivity of the conducting material serving as electrically conductive means). These resistances work in parallel, and this even if the electrically conductive means is not connected to the electrochemical detection circuit. Thus, the resulting global resistance, Rg, is approximately equal to Rc, so that the electrically conductive means acts as a kind of by-pass of resistance, which provides a more favourable route for the current. The applied potential can thus be maintained approximately constant along the entire microstructure (even in the presence of large currents) because of the very low global resistance of the system. The integration of an electrically conductive means thus prevents perturbation of the electrochemical signal due to iR drop, and the present invention thus provides a powerful means to improve the quality of the signals that can be obtained for electrochemical detection in a microsensor system.

It should be noted here that electrophoresis would not be possible in the device of this invention, since the electrically conductive means would maintain an approximately constant potential along the microstructure, so that almost no gradient of electric field could be generated, thereby hindering electroosmosis as well as electrophoretic separation.

This invention provides a microfluidic device comprising at least one microstructure which comprises one or a series of working electrode(s), as well as an electrically conductive means integrated inside the microstructure(s) in such a manner as to reduce the ohmic resistance within this microstructure. Reduction of the ohmic resistance is particularly needed in sensors of small dimensions (e.g. in microchannels) or when large current densities are used, because the ohmic resistance disturbs the signal that can be measured electrochemically. The microfluidic device of this invention is directed to electrochemical sensors having reduced ohmic resistance, thereby enabling improved electrochemical responses.

In one embodiment of the invention, the electrically conductive means is connected as the counter-electrode, which can advantageously be used during reduction or oxidation (or “redox”) reactions to regenerate the analyte to detect. In an alternative embodiment, this conductive means is not connected to an external electric meter (e.g. a potentiostat, a power supply, etc.). Hence, in such a configuration, the electrically conductive means is not an electrode (since it is not connected), but only a tool added to the microfluidic sensor device in order to conduct the current around a path of high electrical resistance (e.g. a solution in a microchannel), thereby allowing a decrease in the overall resistance of the system. Such an electrically conductive means can reduce the ohmic resistance in the microstructure and hence optimise the signal that can be obtained for a redox reaction. For instance, with a microchannel comprising an electrically conductive means along its entire length and a counter electrode or a pseudo-reference electrode placed at the inlet or outlet of the -microchannel while the working electrode is integrated within a wall portion of the microchannel, the electrically conductive means (even when it is not connected) enables transport of the current along the microchannel and hence over the distance separating the working electrode from the counter or pseudo-reference electrode placed at the inlet or outlet, which enables a minimised resistance and hence an optimised electrochemical signal that can be obtained with such a device.

It should be stressed here that the device of the invention does not necessarily contain the reference or pseudo-reference electrode. Indeed, the reference or pseudo-reference electrode can be provided by another piece of instrumentation, and hence is not an integral part of the microfluidic device. For example, the reference or pseudo-reference electrode can be a silver/silver chloride wire that is placed in a reservoir at the inlet or outlet of the microstructure or in a means serving for dispensing solution into the microfluidic device (such as e.g. a syringe), in such a manner that this reference or pseudo-reference electrode is in contact with the analyte solution during electrochemical detection. This can advantageously achieved when the microfluidic device of the invention is intended to be disposable and hence thrown away after each assay or after a well-defined series of experiments, while the reference or pseudo-reference is intended to remain even when the microfluidic device is replaced by a new one.

A further aspect of this invention provides a method of fabricating a microfluidic device, including integrating electrically conductive means to be in contact with a solution to be present in the microstructure so as to minimise the ohmic resistance within the microstructure. In one embodiment, the electrically conductive means is formed with at least one through-hole serving as a mask to manufacture the microstructure in the substrate supporting the microstructure and in which under-etching around the mask is performed such that the electrically conductive means can be in contact with the solution to be present in the microfluidic device.

A third aspect of the present invention provides the use of the electrochemical microfluidic device according to claim 49.

The device and method of the invention can advantageously be used in electrochemical sensor applications, and more particularly in chemical and/or biological analysis for instance physicochemical characterisation of compounds or analytical testing e.g. immunological, enzymatic, ion, DNA, peptide, oligonucleotide or cellular assays. The invention can find many applications in medical diagnostics, veterinary testing, environmental or water analysis, quality control, industrial control, pharmaceutical research, detection of warfare agents, monitoring of production processes, etc.

The present invention thus provides a microfluidic device comprising one or a plurality of electrically conductive means allowing minimised ohmic resistance within a microstructure (generally a microchannel or a network of microchannels). The microfluidic device of this invention also comprises one or a plurality of working electrode(s) (preferably micro-electrode(s)) in addition to said electrically conductive means. Both the working electrode(s) and the electrically conductive means may be integrated in wall portions of the microstructure in such a manner that they face each other, so as to minimise the distance between each individual working electrode(s) and the electrically conductive means. Generally, the reference or pseudo-reference electrode is also part of the microfluidic device (preferably placed at the inlet and/or outlet of the microstructure when it is a microchannel), and one or a series of counter-electrode(s) can also be part of the microfluidic device in order to enable electrochemical detection in a three-electrode mode.

There is no restriction in the size and shape of the microfluidic device or of the microstructure, which can be fabricated by any means (for instance, but not limited to, injection moulding, embossing, polymer casting, silicon etching, UV Liga, wet etching or dry etching) and in any electrically insulating material (for instance glass, quartz, ceramic, polymer or combination thereof). In an embodiment, the microfluidic device is composed of an assembly of materials and solid structures: for instance in a microfluidic sensor made of a polymer foil serving as microstructure support in which the various electrodes, the electrically conductive means and the connection pads and tracks can be present (as in a printed circuit board system), as well as a cover layer e.g of a polymer or glass which serves to seal or cover the microstructure in order to enable microfluidic manipulations. An additional part can be made of another polymer material and may for instance comprise access hole(s) to the inlet(s) and/or outlet(s) and additional reservoirs, enabling sample and reagent introduction or withdrawal and/or connection to fluidic control unit(s), which can also provide rigidity to the entire sensor device or which can also enable microfluidic sensor cartridges of relatively large size compared to the microstructure itself, so as to facilitate the handling of the sensor. Such a multi-structure and multi-material device can advantageously be fabricated by a pick-and-place approach where the microstructure support with its cover layer is cut from a panel or board comprising a series of microstructures before being precisely assembled (e.g. by gluing) to an additional part (e.g. an injection-moulded structure) having access holes for fluidic and/or electrical connection and optionally sample or reagent reservoirs (see for instance the example of FIG. 15 below). Further electrically conductive tracks and pads can also be created in order to ensure or facilitate electrical connection, or to integrate a reference electrode (like a silver or silver/silver chloride ink dot). Other process can be used to fabricate such microfluidic sensor device, as for instance by over-moulding the microstructure support and its cover layer with polymer part(s) adapted to provide for instance access holes and/or reagent reservoirs.

The working electrodes are adapted to control, monitor and/or measure one or several electrochemical property(ies) of the fluid present in said microfluidic device. In particular, these electrodes are adapted to perform amperometric, cyclic voltammetric, chrono-amperometric and/or impedance measurements, and the device of the invention can be advantageously used in chemical and/or biological applications such as but not limited to immunological, enzymatic, affinity, ion, peptide, DNA, oligonucleotide or cellular assays, as well as in physico-chemical tests, for instance solubility, lipophilicity or permeability assays or determination of redox properties. Depending on the applications, the microstructure can also advantageously be functionalised with chemical and/or biological compound(s). To this end, functional groups can be created (e.g. by chemical or physical means) on the inner surface of the microstructure. For instance carboxylic, amino, thiol or phenol groups can be integrated by chemical reaction with the material(s) constituting the microstructure surface or with that serving as electrode(s) or electrically conductive means. Chemical and/or biological compounds can also advantageously be reversibly or irreversibly immobilised in at least one portion of the microstructure, for instance but not limited to adsorption, ionic bonding or covalent binding. The chemical and/or biological compound(s) can be immobilised on at least one part of the microstructure walls and/or on the integrated working electrode(s) and electrically conductive means. In one embodiment, the device of the invention can be adapted in order to keep only the integrated working electrode(s) without immobilised compound(s), that is to say that the device can be adapted to allow immobilisation of chemical and/or biological compound(s) on the walls of the microstructure, but without touching the working electrode(s). To this end, the microfluidic device can advantageously be fabricated in such a manner that the working electrode(s) is(are) recessed with respect to the microstructure. Such recess(es) can be made hydrophobic and/or have a shape appropriate to let an hydrophilic solution flowing through the microstructure pass over this(these) recess(es) without touching the working electrode(s), thereby preventing its(their) functionalisation with a chemical or biological material. In such microfluidic devices, multiple-step assays can for instance be run in such a manner that the solutions (e.g. sample, buffer, washing medium, revelation of captured molecules) do not enter into contact with the working electrode(s) as long as a solution capable of wetting the working electrode(s) has not been introduced in the microstructure. When the microstructure has been filled with such a wetting solution, as can for instance be achieved with a surfactant as Tween buffer in polyimide microchannels having recessed gold working electrodes), the hydrophobicity of the recess is reduced, so that the filling of the microstructure with other, even hydrophilic solutions, will still wet the working electrode(s). The introduction of the wetting solution can be carried out at any step of an assay, depending when it is desired that the working electrode(s) are in contact with the solution present in the microstructure. In multi-step assays such as immunological tests, it can indeed be advantageous to run all steps of the assay (capture of the desired analyte, washing, incubation of the secondary antibody and additional washing) without having any contact between these various solutions and the working electrode(s) and to add a wetting solution (which can for instance comprise the enzymatic substrate serving to reveal the captured analytes) just before the detection.

In another embodiment, the device of this invention can also be manufactured in such a way that only the working electrode(s) is(are) functionalised with a chemical or biological material. This can for instance be achieved by deposition directly on the working electrode(s) only. Such a process can be used to functionalise the working electrode(s) with for instance oligonucleotide(s), DNA strain(s) or cell(s).

In some embodiments, a dried reagent can also be used to functionalise the microfluidic device, and functionalisation can also be achieved by use of beads, membrane(s) or filter(s) comprising the desired chemical and/or biological entity(ies).

In one embodiment, the microfluidic device of the present invention is a two-electrode system comprising at least one working electrode (or array of working electrodes) that is integrated in at least one wall portion of the microstructure and one pseudo-reference electrode (i.e. an electrode playing the roles of both the reference and the counter electrodes); in such a 2-electrode configuration, the electrically conductive means is present in addition to the working and pseudo-reference electrodes but is not connected so that it is not part of the 2-electrode system serving for the electrochemical detection; in this case, the pseudo-reference electrode can advantageously be placed outside the micro-structure, close to the inlet and/or outlet and in such a manner as to be in contact with the solution to probe. Due to the nature of the electrically conductive means, the resistance is dramatically decreased along the microstructure(s), thereby enabling optimal electrochemical manipulation and detection; the fact that the electrically conductive means does not need to be connected as a counter-electrode was not expected, but constitutes a supplementary advantage of the present invention.

In another embodiment, the device of the present invention constitutes a three-electrode system comprising at least one working electrode (or array of working electrodes), at least one reference electrode and at least one electrically conductive means. In one embodiment, the electrically conductive means can be adapted to directly serve as counter electrode. In another embodiment, the electrically conductive means is not part of the three-electrode system, it is not connected to the electrodes, and the device further comprises at least one additional electrode serving as counter-electrode.

In an embodiment, the microfluidic device of the invention comprises an electrically conductive means along the entire length of the microstructure, and the electrically conductive means can advantageously surround the microstructure and form a frieze of conducting material in contact with the solution present in the microstructure.

In a further embodiment, the electrically conductive means and the reference or pseudo-reference electrode can also be short-circuited. This can for instance be achieved by providing a microfluidic device where the electrically conductive means is a conducting pad forming a frieze around the microstructure which encompasses the inlet and/or outlet and where the reference or pseudo-reference electrode is simply deposited on this conducting pad on the external side of the inlet and/or outlet but a such a manner that is is in contact with the solution.

In some applications of the present invention, the counter-electrode can be used to re-generate the product of the reaction taking place at the working electrode(s), thereby increasing the measured signal and hence improving the analytical sensitivity of the device. The electrically conductive means can advantageously be used for this purpose; in such a case, the electrically conductive means would play both the roles of counter-electrode, of re-generation of the compound to detect and of minimizing the resistance along the microstructure.

In a further embodiment of the present invention, the microfluidic device may comprise at least one biological and/or chemical entity. Such a biological or chemical moiety can be immobilized either by physisorption, covalent binding, ionic bonding or simply dried on at least one portion of at least one wall of the microstructure(s). In another embodiment, the microfluidic device may also comprise beads and/or a membrane (which can be placed for instance at the inlet and/or outlet of the microstructure) so as to capture one or a plurality of target sample molecules or to wash or desalt a sample. Such beads or membrane may also comprise one or a plurality of biological and/or chemical entity(ies), which can be immobilized on these types of supports.

The microstructure walls and/or the integrated electrode(s) or electrically conductive means can also be partially coated by an organic phase (solidified or not) that can for instance be used as a protective layer for the electrode(s) or as a phase immiscible with the sample solution and can be set-up for measurements of ion transfer reactions at the interface between two immiscible solutions and can for instance be used for the dosage of ions.

The microfluidic device can be surrounded by a supplementary layer which can be used as a solidifier and/or comprise reservoirs (e.g. for stocking of reagents and/or washing solution), as well as access holes for fluidic and/or electrical connection, or guides for interfacing with other instruments.

In the microfluidic device of this invention, there is no limitation in the chemical and/or physical nature of the microstructure substrate or of the cover layer. Each of the substrate and cover layer can for instance be made of a polymer (like but not limited to polyimide, polystyrene, polycarbonate, polyethylene, polyethylene terephthalate, liquid crystal polymer), glass, quartz, a ceramic, etc. In the present invention, the term “substrate” actually refers to any material in which the microstructure can be fabricated. One substrate is a polymer foil, having a thickness smaller than 1 mm. In one embodiment, the cover layer serves to seal the microstructure so as to enable microfluidic manipulations (such as with microchannels), and this cover layer may also comprise a microstructure and/or conductive pads in which one or a plurality of electrode(s) can be fabricated. Similarly, there is no limitation in the materials and/or nature of the microfluidic device of the present invention, nor in the shape and size of the microstructures, provided that a “microstructure” generally has at least one dimension smaller than 1 mm. In a preferred embodiment, the microfluidic device is yet a multilayer body constituted by at least an assembly of a microstructure substrate, electrically conducting tracks to form the electrode(s) and/or the electrically conductive means serving to reduce the ohmic resistance of the device, as well as a cover layer generally serving to seal the microstructure (thereby enabling microfluidic manipulations). In a further preferred embodiment, the cover layer is a polymer layer that is laminated or glued on the microstructure substrate.

The electrically conductive means as well as the electrode(s) can be made of any electrically conductive material such as but not limited to a metal (e.g. gold, silver, platinum or any inert metal) or a metal assembly (e.g. for instance copper coated (e.g. by electroplating) with gold, silver, platinum or the like), an electrically conductive ink (e.g. Ag/AgCl ink) or gel (e.g. ion permeable gels).

In the present method of fabricating a microfluidic system, the ohmic resistance is reduced due to the presence of one or a plurality of electrically conductive means. In one embodiment, the invention provides a particular arrangement in a multilayer body comprising a substrate having one or a plurality of microstructure(s) (preferably microchannel(s)), one or a plurality of electrically conductive means defining at least one wall portion of the microstructure(s) and a cover layer in order to cover and/or seal said microstructure(s). In certain microfluidic devices of the invention, the or the plurality of electrically conductive means comprise(s) one or a plurality of grooves or holes which is(are) part of the microstructure(s) when said microstructures is(are) covered or sealed on the side of the electrically conductive means (see FIG. 1).

In another embodiment, the invention provides a method of producing electrochemical microfluidic devices which comprise an electrically conductive means comprising one or a plurality of through-holes along at least one portion of the microstructure(s); by covering or sealing of the microstructure by application of a cover layer, these holes can be sealed on their side opposite to the microstructure(s), so that they become part of the microstructure(s), which has then at least one wall portion made of an assembly of different materials (namely part of the microstructure substrate, part of the material of the electrically conductive means and part of the cover layer, as illustrated below in the cross-section of FIG. 2. When the microstructure is filled with a solution, the solution in the microstructure shall then be automatically in contact with the electrically conducting means, as can be easily deduced from the shape and the different elements constituting the microstructure shown below in the example of FIGS. 1 and 2. In a preferred embodiment, the electrically conducting means can thus exhibit a through-hole, and this assembly can also advantageously serve as patterning mask for the fabrication of the microstructure(s) in the substrate; indeed, the electrically conductive means may for instance be directly deposited on the microstructure substrate and structured (for instance by conventional photoresist deposition followed by light exposition (for instance in a high-resolution computer-driven printer)) in order to form through-holes of the desired pattern for further microfabrication. The electrically conductive means thus forms a mask and, in a second fabrication step, the microstructure(s) is(are) fabricated in said substrate (e.g. by wet etching, chemical etching, photoablation or a combination thereof), thank to the parts of the substrate that are exposed to the etching or ablation medium. In a preferred embodiment, the microfabrication step is selected from an isotropic etching process (like e.g. plasma or gas etching, or any wet etching process), because such isotropic process results in an etching in the three spatial dimensions and hence in elimination of material on the side of the mask. This phenomenon, known as “under-etching”, enables to make sure that the electrically conductive means will be in contact with a solution present in the microstructure(s), even when this microstructure(s) is(are) covered or sealed (for instance by a lamination layer).

After fabrication of said microstructure, undesirable electrically conductive parts (generally used to protect the substrate portions that should not be exposed during the etching step of the microfabrication process) can be removed (e.g. by chemical etching) so as to give the desired design to the electrically conducting means and to the pads and tracks connecting the other electrodes. The electrodes can indeed also be integrated during this process, before adding the cover layer serving to close or seal the microstructure(s). One or a plurality of working electrode(s) for instance can be integrated in wall portions of the microstracture(s), and preferably from the side of the microstructure substrate which is opposite to the electrically conductive means. Such a disposition can indeed be chosen to facilitate the fabrication of the entire microfluidic device, but also to minimise the distance between the integrated working electrode(s) and the electrically conductive means, thereby reducing the ohmic resistance to a minimum, providing small diffusion distances when the electrically conductive means is used as counter-electrodes and serves to regenerate the analyte to detect.

When the microstructure has to be functionalised (e.g. by immobilisation of biological and/or chemical material), it may be advantageous to wash or modify at least one portion of the microstructure walls by physical (e.g. by exposition to a plasma) and/or chemical means (acidic or basic treatment). Similarly, functionalisation of the microstructure(s) may be advantageously carried out before addition of the cover layer.

### BRIEF DESCRIPTION OF THE DRAWINGS

Specific embodiments of the invention will now be described through reference to the accompanying drawings (but without being restricted to the features shown therein), in which:

FIG. 1 shows a schematic longitudinal section of an example of electrochemical microfluidic device (1) of the present invention, in the direction of the microchannel constituting here the microstructure (2);

FIG. 2 shows a schematic transverse section of the device of FIG. 1, in the direction perpendicular to the microchannel (2), i.e. following the axis A shown in FIG. 1;

FIG. 3 shows a three-dimensional view of a portion of an electrochemical microfluidic device of the invention where the electrically conductive means (7) forms a frieze around a microchannel (2) integrating recessed working electrodes (4′) supported by a pad (5) having an exposed surface made of an electrochemically inert material.

FIG. 4 shows a schematic longitudinal section of an example for the fabrication steps that can be used to manufacture a microfluidic device of the present invention;

FIG. 5 shows a schematic transverse section of an example for the fabrication steps that can be used to manufacture the device of FIGS. 1 and 2, steps 5A to 5E corresponding to steps 4D to 4H of FIG. 4, respectively;

FIG. 6 shows a top view of a microfluidic device of the invention with conductive tracks (11) to enable the contact of the working electrode (4), pseudo reference electrode (6) and eventually the conductive means (7) to their respective pads (12);

FIG. 7 presents photographs of a top view (A) and bottom view (B) of a system comprising eight independent microfluidic devices of the invention replicated in a 75 micrometer thick polyimide foil (3) and that have the same features as those schematically shown in FIG. 6;

FIG. 8 presents a microscope photograph of a cross-section of a device of the invention, in the direction perpendicular to the direction of the microchannel (2) which has been produced in a 50 micrometer thick polyimide substrate (3); this picture shows the electrically conductive means (7) composed of the remaining copper parts (7′) of the mask serving for the microstructure fabrication that are covered with a gold layer (7″), as well as one recessed working electrode (4) supported by the remaining copper part (5′) of the mask serving for the fabrication of the microstructure inlet and outlet which is also covered with gold;

FIG. 9 shows cyclic voltammograms obtained for the detection of 0.5 mM ferrocene carboxylic acid in a 1 cm long×˜100 micrometer diameter microchannel with 24 integrated working microelectrodes of 50 μm diameter at a scan rate varying from 1 V/s (curve A) to 5 V/s (curve E), when no electrically conductive means is present in the microfluidic device (prior art);

FIG. 10 shows the cyclic voltammograms obtained for the detection, in a 2-electrode mode, of 0.5 mM ferrocene carboxylic acid in a 1 cm long×˜100 micrometer diameter microchannel with 24 gold-coated copper working microelectrodes of 50 micron diameter integrated along the microchannel of a device similar to that shown in FIGS. 5 and 6, at a scan rate varying from 1 V/s (curve A) to 5 V/s (curve E), when the microfluidic device comprises a thin gold-coated copper layer along the microchannel serving as not-connected electrically conductive means;

FIG. 11 shows the chronoamperograms obtained for the detection of 0.5 mM ferrocene carboxylic acid in: A) a two-electrode system where the electrically conductive means is not connected and where a pseudo-reference electrode is placed outside the microstructure close to the microchannel inlet or outlet) and B) in a three-electrode system where the conductive means serves as counter-electrode and where the microfluidic device further comprises a third, reference electrode outside the microstructure close to the microchannel inlet or outlet, in the same configuration as that shown in FIG. 6;

FIG. 12 shows the chrono-amperometric responses of an enzymatic reaction obtained for the detection at 200 mV of p-aminophenol generated by the hydrolysis reaction of alkaline phosphatase with p-aminophenyl phosphate the detection is performed: A) in a two-electrode mode (i.e. in a configuration where an electrode in the reservoir at the inlet or outlet of the microstructure serves as pseudo-reference electrode (i.e. as both counter and reference electrodes)) and where the electrically conductive means is present but not connected); B) in a three-electrode mode (i.e. in a configuration where the electrically conductive means is connected as counter-electrode and where an electrode in the reservoir at the inlet or outlet of the microstructure serves as reference electrode);

FIG. 13 shows the time evolution of the current obtained for TSH immunoassays at 56.1 μUI/mL in 2-electrode microfluidic sensor devices with (A) and without (B) integrated electrically conductive means, both microfluidic devices comprising microchannels having sensibly the same geometrical characteristics (namely ˜1 cm in length and ˜50 micrometer in depth) as well as 48 integrated gold working electrodes and an Ag/AgCl pseudo-reference electrode placed at the inlet of the microchannel.

FIG. 14 is an isometric view of an example of microfluidic device of this invention, which further comprises: a top layer (30) serving as a solidifier or solid support; a hole (31) in one portion of the top layer which enables to have a reservoir to access the microstructure entrance (entrance not shown in the figure); one or a plurality of supplementary reservoirs (32) that can contain reagents in dried or wet form; and guides (33) that enable easy connection to an instrument and/or precise alignment with external connection, sampling and/or dispensing means. The top layer is made in such a way that the conductive tracks (12) are still available for the electrical connection with external instrumentation like e.g. a potentiostat; and

FIG. 15 shows a view, from the back side, of the example of microfluidic device shown in FIG. 14, in which the connecting tracks (12′) allows for the connection of the electrically conducting means to an external instrument (such as a potentiostat).

### DETAILED DESCRIPTION OF PARTICULAR EMBODIMENTS

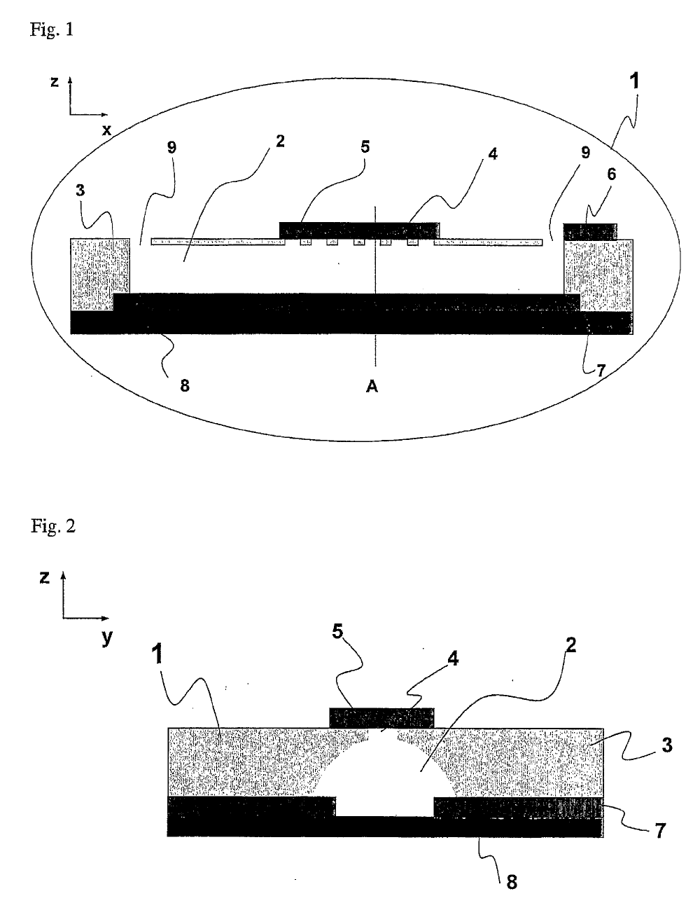

FIG. 1 is a longitudinal cross-section view of an example of microfluidic device of the present invention (1) which comprises a microstructure (2) fabricated in a substrate (3) (selected preferentially from, but not limited to, a non-conducting polymer material), said microstructure comprising one or a plurality of microelectrode(s) or microelectrode array(s) (4) as working electrode(s), generally exhibiting one or several conducting connection pad(s) (5) for connection to an external potentiostat, as well as an electrically conductive means (7) which is in direct contact with the microstructure(s) and which, in the present case, is placed in front of the working microelectrode(s), on the opposite side of the microstructure substrate. The microstructure of FIG. 1 is sealed by a cover layer (8), which can for instance be glued or laminated at the end of the fabrication process. In the case of FIG. 1, the microstructure is a microchannel comprising access holes (9) serving as inlet and outlet, and enabling fluid introduction, uptake, withdrawal or dispensing.

In a preferred embodiment described in FIGS. 1 and 2, the microfluidic device is made of a polymer body with at least one electrode (made of any appropriate material, like e.g. a metal). This microfluidic device (1) is composed of at least one microstructure (2) embedded in a substrate (3), where said microstructure defines a cross section of preferably less than 500 μm, said microstructure having an integrated microelectrode or microelectrode array (4) said microelectrode or microelectrode array being supported by a conductive pad (5); the microfluidic device also comprises a pseudo-reference or a reference electrode composed of for instance a dot of conductive ink (e.g. an Ag/AgCl ink) deposited on another conductive pad (6), which can advantageously be placed in contact with the solution at the inlet and/or outlet of the microstructure; the microstructure further comprises an electrically conductive means (7), said electrically conductive means (7) being present in a significant part or along the entire length of microstructure; the electrodes, electrically conductive means and connection pads or tracks can for instance be made of copper coated with an inert metal like gold, as in the demonstration example described below. The microstructure is preferably covered by a lamination layer (8); in the embodiment shown, the microstructure (2) is a microchannel with two fluid access holes (9) to enable the solution to enter and quit the microstructure.

In this embodiment of the microfluidic electrochemical sensor of this invention, the pseudo-reference electrode (when working in 2-electrode mode) is placed outside the microstructure, close to the inlet and/or outlet but adapted to be in contact with the solution to probe, so as to simplify the manufacturing process. In this case, the distance between the working electrode(s) integrated within the microstructure and the pseudo-reference electrode is rather large, which, in addition to the small section of the microstructure, tends to result in relatively large resistance and hence in perturbation of the electrochemical response. The integration of the electrically conductive means allows one to minimise the resistance between the working and the pseudo-reference electrode. As can be deduced from the schematic illustration of FIG. 1, if the microstructure is a microchannel of 1 cm in length and 50 μm diameter having an integrated working electrode positioned in the middle of the channel (i.e. at 5 mm from the inlet), a pseudo-reference electrode placed at the microchannel inlet, an electrically conductive means placed in front of the working electrode and along the entire length of the microchannel, the iR drop is mainly due to resistance between the working electrode and the electrically conductive means, which is very small. Indeed, the ratio L/A of Equation 1 is very favourable, since, in the geometry of the present example, L would be the microchannel depth (namely 50 μm), while the cross-section to consider, A, should be taken as the microchannel width (i.e. about 50 μm here) multiplied by the microchannel length (namely 1 cm) since the electrically conductive means is present along the entire microchannel. In this manner, the ratio L/A would be 10² m⁻¹, so that the resistance in a 100 mM phosphate buffer solution would be about 100Ω. Taking into account that, between the pseudo-reference electrode and the electrically conductive means, the same resistance shall apply in series, the global resistance of the device would be approximately 200Ω, so that a current of 100 nA would generate an iR drop of only 20 μV.

In the case where there is no electrically conductive means integrated along the microchannel, the iR drop would be given by the resistance of the current flowing over the 0.5 cm separating the pseudo-reference electrode and the working electrode (in the case where the working electrode is placed in the middle of the microchannel length), so that the ratio L/A would be 0.5 cm * (50 μm)²=2*106 m⁻¹. In this case, the global resistance of the device would be ·10⁶Ω (which is thus about which is thus 5000 times larger than in the same microfluidic device incorporating an electrically conductive means), and a current of 100 nA would thus generate an iR drop of ˜100 mV, which represents an important shift of potential which disturbs electrochemical measurement.

It should be noted here that, when the electrically conductive means is connected as counter-electrode, the resistance path is the same as in the above described case (where the electrically conductive means is present but not connected) so that the ohmic resistance is also minimised as well as the iR drop.

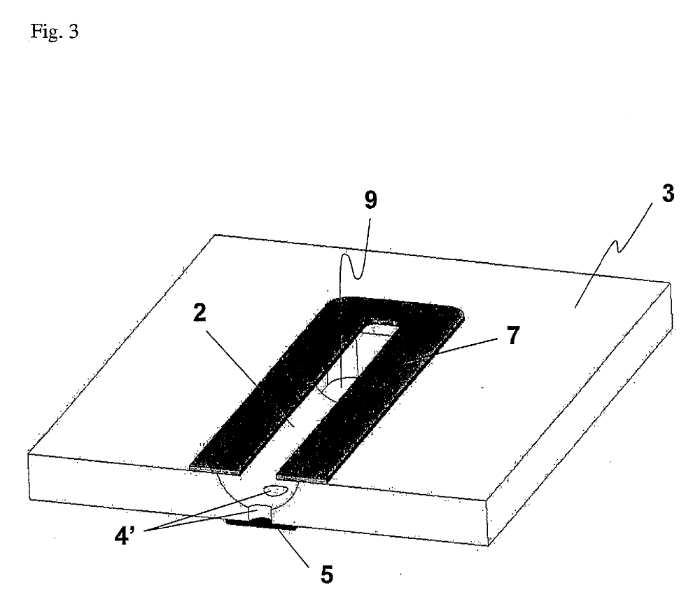

FIG. 3 shows a three-dimensional portion of an electrochemical microfluidic device of the invention where the electrically conductive means (7) is fabricated in such a manner that it surrounds the microstructure which is here a microchannel (2) having recessed working electrodes (4′) supported on a conductive pad which has an exposed surface made of an electrochemically inert material and which is placed on the side of the microstructure substrate (3) which is opposite to that comprising the electrically conductive means. The microstructure is represented in FIG. 3 as an open microchannel that can be sealed on the side of the substrate comprising the electrically conductive means using a cover layer such as a lamination foil, notably in order to enable microfluidic manipulations. In this example, the electrically conductive means forms a frieze around the microchannel, which constitutes a wall portion of the microstructure along its entire length and which ensures the contact with the solution present in the microstructure.

The configuration shown in FIG. 3 can also advantageously be chosen in order to provide photons with an access to the microstructure and hence to the solution present in this microstructure. Indeed, when the microstructure is covered with a transparent material such as but not limited to glass or a polymer such as polyethylene, polyethylene terephthalate, polycarbonate or polystyrene, the centre of the frieze defined by the electrically conductive means is a hole above the microstructure, which defines a window enabling the passage of photons. This feature can be very useful in applications where optical means are required to check what happens within the microstructure or in applications where the solution in the microstructure has to be illuminated or where a detection window is required for optical detection such as but not limited to fluorescence, UV-Vis or chemi- or electrochemi-luminescence.

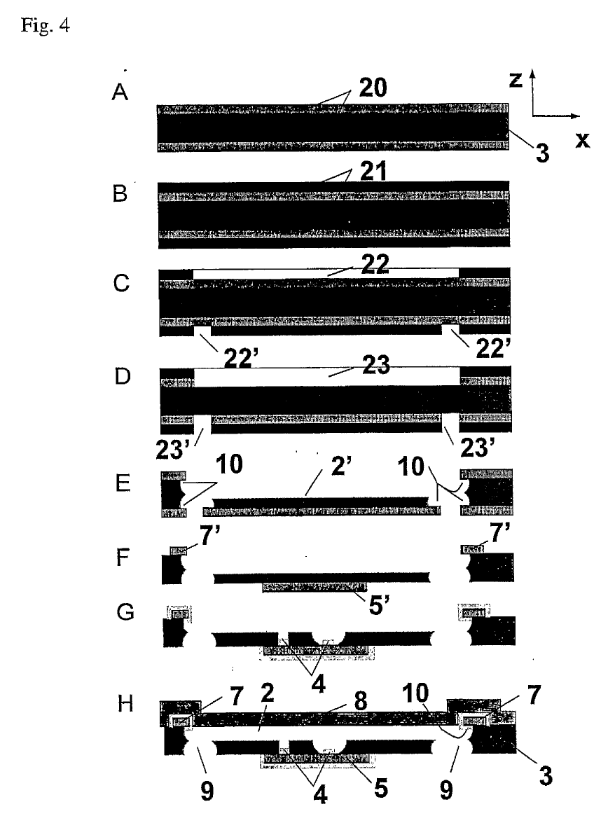

FIG. 4 shows an example, in the x-z plane, of the fabrication steps that can be used to fabricate an example of microfluidic device of the present invention, namely: A) providing a substrate (3) (e.g. polyimide, polycarbonate or liquid crystal polymer) covered on both sides with a protective layer (20) (e.g. a metal such as copper); B) coating a photoresist (21) on both sides of the protective layer (20); C) structuring (e.g. by photolithography) two first masks (22 and 22′) in the photoresist layer on both sides of the multilayer body that correspond to the microstructure to pattern in the substrate (in some embodiment of the invention, the mask is not in direct contact with the substrate, but it is remote as in the case where laser photoablation is used to etch the substrate and fabricate the desired microstructure(s)); D) fabricating (e.g. by chemical etching) definitive masks (23 and 23′) in the protective layer on both sides of the multilayer body so as to expose portions of the substrate; E) Structuring the substrate through the masks (23 and 23′) (preferentially using an isotropic etching process in order to remove part of the substrate material beneath the masks (10) by under-etching) in order to create one or a plurality of non-sealed microstructure(s) (2′) (here having access holes (9)); F) Removing the unnecessary portions of the protective layers covering the substrate (e.g. by chemical etching) in order to create electrically conducting pads (5′ and 7′) that shall serve to create the final electrode connection pads (5) and, respectively, the final electrically conducting means (7) serving to reduce the ohmic resistance of the microsystem; G) Further structuring the substrate above the conducting pads (5′) in order to create one or a plurality of electrode(s) (4) (that can be interconnected or not and create reference, working and/or counter electrodes) and, if necessary, coating of the electrically conducting pads (e.g. by electroplating of an inert metal such as but not limited to gold) in order to create coated electrode(s) (5) and electrically conducting pads (7); as shown in FIG. 4, depending on the process used for this electrode fabrication step (e.g. laser photoablation, etching, mechanical removing, etc.), the electrode may have different shapes and/or expose in the microstructure(s) different shapes (protruding, flat or recessed electrode(s) (with either straight or oblique walls in the substrate)) as well as different geometries (round, polygonal or even a not well-defined shape); G) finally, for many applications, a cover layer (8) is finally added to the device (for instance by lamination or gluing of a polymer layer), thereby enabling microfluidic manipulations.

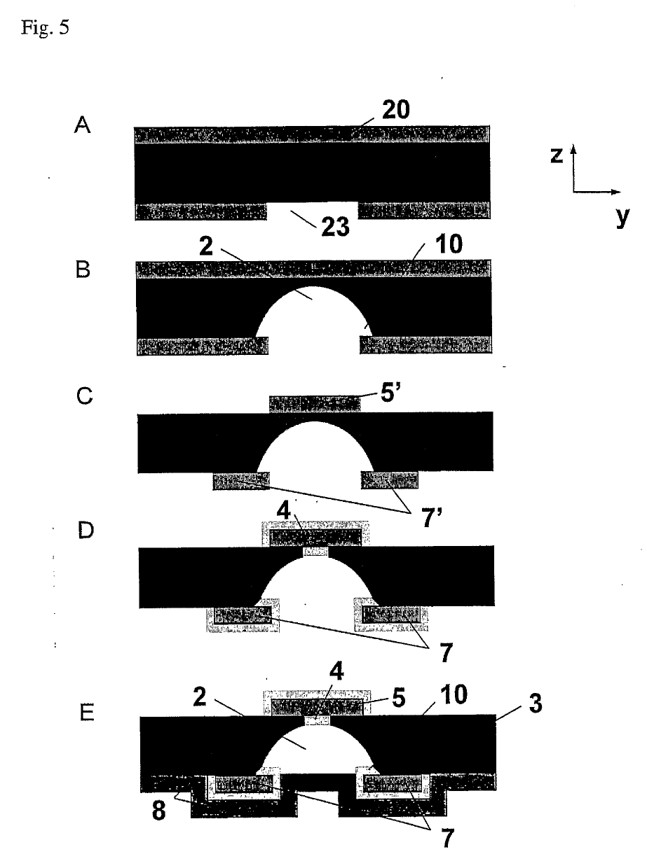

FIG. 5 shows the similar suite of fabrication steps as in FIG. 4, but in the y-z plan and only for the steps of FIG. 4D to 4H, namely: FIG. 5A is the y-z plan representation of FIG. 4D, FIG. 5B that corresponding to FIG. 4E, and so on until FIG. 5E which corresponds to FIG. 4H.

One advantageous optional feature of the method of the present invention consists in using a metallic mask to create the microstructure(s) in a substrate before being structured itself in such a way that it may serve as electrically conductive means. An isotropic etching process can be used to microstructure the substrate and one advantage of such a method relies on the fact that the electrically conducting means first serves as mask for the creation of the microstructure(s), which, during the isotropic etching step, results in the removal of substrate material not only on the open part of the mask but also beneath the mask due to under-etching (10), thereby providing a large surface of contact even after covering the microstructure(s) with a cover layer, which ensures a solution present in the microstructure(s) to be in physical contact with the electrically conductive means, thereby enabling to decrease the ohmic resistance along the microstructure.

The present embodiments do not limit the possible techniques used to fabricate the device of the present invention. Technologies such as but not limited to embossing, injection moulding, polymer casting, silicon etching or UV Liga can be used to fabricate the microstructure.

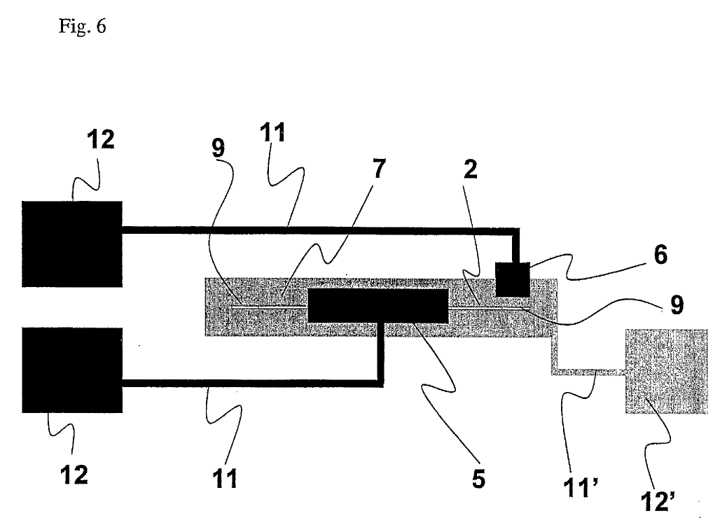

FIG. 6 shows a top view of a microfluidic device according to the invention with conductive tracks (11 and 11 ′) to enable the contact of the working electrode (4), pseudo-reference electrode (6) and eventually the conductive means (7) to their respective pads (12 and 12′) serving for connection to the external world (e.g. to a potentiostat, an impedance measurement system, a multimeter and/or a potentiostat). In the configuration of FIG. 6, the electrical pad (5) serving to support and define the integrated working electrode(s) as well as the reference electrode (6) are placed on the top side of the microfluidic device, while the electrically conductive means (7) and its corresponding conductive tracks (11′) and (12′) are placed on the opposite side of the microstructure substrate.

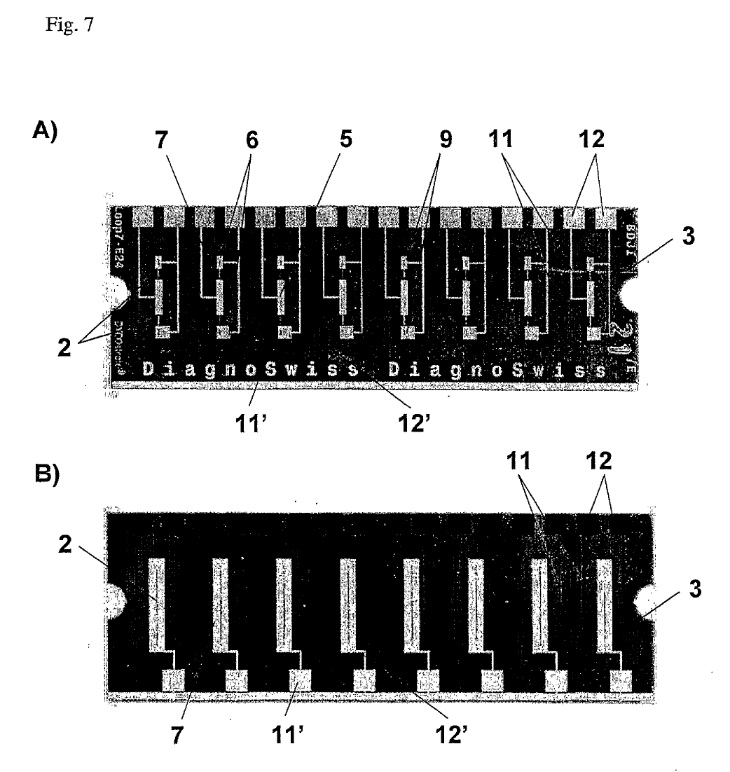

FIG. 7 presents photographs (top (A) and bottom (B) views) of a 75 μm thick polyimide foil (3) in which 8 independent microfluidic devices having the same characteristics as those described for FIG. 6 have been fabricated using a plasma etching process.

Each of these microfluidic devices comprises a 1 cm long microchannel (2), a gold-coated copper support (5) which contains 24 working electrodes of 50 μm diameter exhibiting a recess of about 15 μm with respect to the microchannel wall, gold-coated copper pads (6) for the reference and/or counter-electrode (an Ag/AgCl dot is used but not shown here), access holes (9) serving as inlet and outlet, and electrical tracks (11) and pads (12) serving for connection to an external electrical meter such as a potentiostat. On the opposite side of the polyimide support (3), each device also comprises an electrically conductive means (7) made of copper coated with gold as well as electrical tracks (11′) and pads (12′) serving for connection that can for instance be used in order to connect the electrically conductive means as counter-electrode. In the present example, the electrically conductive means surrounds the microchannel (2) because it first served as a mask to etch the microstructure. On its side comprising the electrically conductive means, the polyimide support is covered by a polyethylene/polyethylene terephthalate layer of ˜32 μm thickness which cannot be seen in FIG. 7 because of its transparency and which enables to create sealed microchannels (2).

As shortly mentioned above in relation with FIG. 7, the electrically conductive means (7) can for instance be the remaining part of the metallic mask used to create the microstructure in the substrate. In such a case, the mask exhibits a groove pattern that allows us to expose the substrate to the etching or ablation medium (e.g. a chemical solution in case of wet etching, a plasma in case of physical or dry etching, or a laser beam in case of photoablation). The microstructure is thus fabricated by exposing the substrate to the etching or ablation medium during the time period necessary to form the desired microstructure (shape and dimensions). Access holes (generally inlet and/or outlet) can be fabricated similarly (and even simultaneously to the microstructure in etching processes) by providing an additional mask on the opposite side of the substrate, which allows to exposing the desired substrate portions, as for example at the positions corresponding to the extremities of the microstructure to fabricate. In this manner, the substrate can be etched from both sides, and exposition time can be chosen so as to ensure that through-holes are created at the positions defined by this additional mask. Precise alignment between the two masks is required in this process so as to ensure that the parts etched from both sides of the substrate are correctly super-imposed. The non-desired parts of the metallic masks can then be removed (while maintaining the portions required to serve as support for the electrodes, as electrically conductive means or as connection tracks or pads), and the remaining parts can be coated with an metal adapted to serve as electrode such as gold, silver, platinum, titanium or the like. Finally, the microstructure can be closed on the side of the substrate comprising the electrically conductive means (e.g. by lamination or gluing of a cover layer), in such a manner that the through-holes are also closed on this side of the substrate, thereby providing a sealed microstructure with inlet and/or outlet that are accessible from the other side of the substrate.

It should also be noted here that the presence of the electrically conductive means on the side of the chip substrate used to close the microstructure can also facilitate the application of the cover layer serving for the sealing. It has indeed been empirically shown with the fabrication of the microfluidic devices shown in FIG. 7 that the relatively large electrically conductive means (7) stabilises the polyethylene/polyethylene terephthalate lamination layer, which does not show any binding or deformation which could indeed block the microstructure.

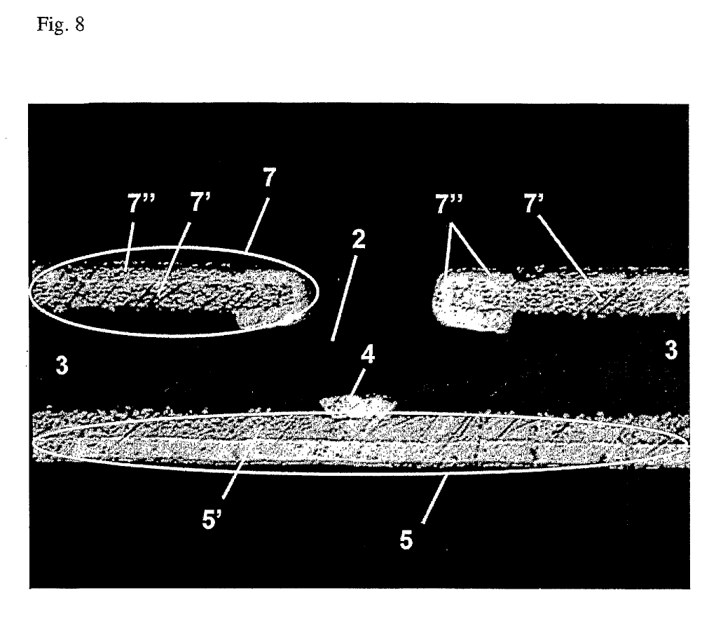

FIG. 8 indeed illustrates the assembly of materials and the shape of the microstructure with integrated working electrode and electrically conductive means for an example of electrochemical microfluidic sensor of the present invention before sealing of the microstructure with e.g. a lamination layer. The photograph of FIG. 8 indeed shows a cross-section of a device of the invention having the same characteristics as those shown in FIGS. 6 and that has been produced in a 50 μm thick polyimide foil using an etching process similar to that described in relation with FIGS. 4 and 5. In this example, the electrically conductive means (7) forming a frieze around the top of the microstructurel (2) (here a microchannel) is made of copper (7′) coated with gold (7″), and the copper portion (7′) of the electrically conductive means (7) is the remaining part of the mask used to create the microstructure in the substrate, while the gold layer (7″) coated over the copper portion (7′) has been manufactured by electroplating of the exposed copper surfaces. This figure also shows one of the integrated working electrodes (4) which has been fabricated by eliminating parts of the polyimide substrate at the bottom of the microstructure so as to expose well-defined portions of the copper support (5′) which served as mask for the fabrication of the microstructure inlet and outlet (not shown here). Recesses are then formed at the bottom of the microstructure, and the working electrodes (4) are then formed by electroplating gold on the exposed portions of this copper support (5′).

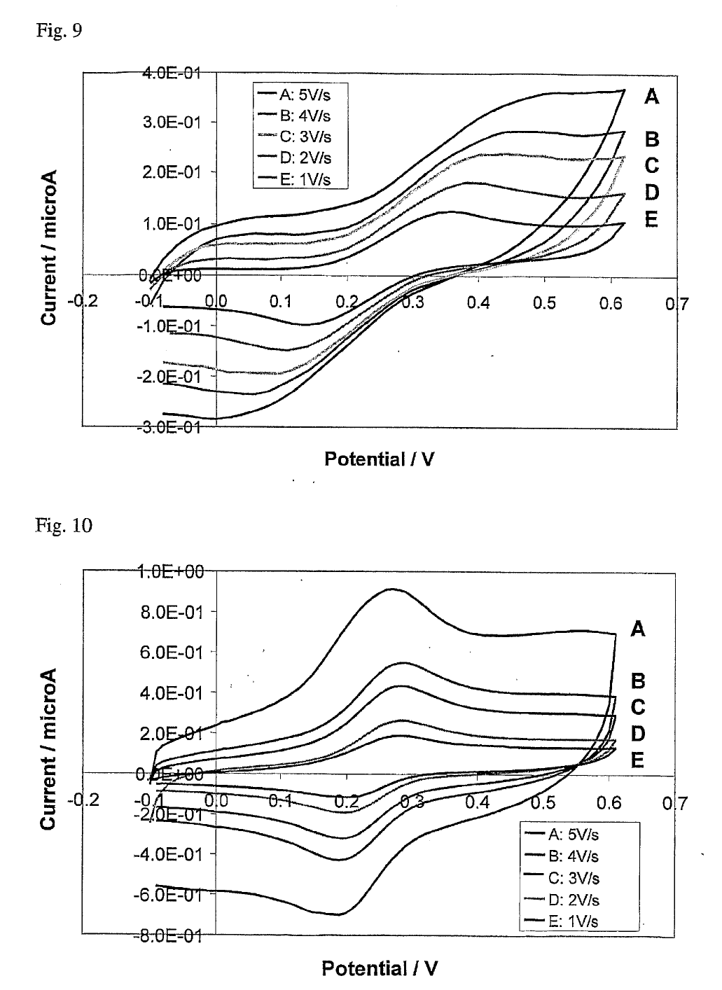

The object of the present invention has been demonstrated by the fabrication of a polymer microfluidic device (1) where the conductive means (7) is a gold coated copper layer surrounding a microstructure (2), which, in this particular case, is a microchannel of 1 cm in length and about 100 micrometer in diameter produced by isotropic etching of a polyimide foil coated on both sides with copper. The working electrode (4) and pseudo-reference electrode (6) are gold-coated copper electrodes that are connected to a potentiostat due to their respective pads (12). The working electrode array (4) is composed of 24 microelectrodes of 50 μm in diameter. The present microstructures are sealed by lamination of a 32 μm thick layer made of polyethylene and polyethylene terephthalate. Detection of 0.5 mM ferrocene carboxylic acid without the conductive means (7) is presented in FIG. 9, where cyclic voltammetry is used to highlight the effect of resistance when larger currents are generated. Indeed, the current intensity increases with the scan rate of the voltammetry. At low scan rates, the voltammogram nicely shows forward wave and back wave with a peak-to-peak separation of about 100 mV, whereas at higher scan rate, the peaks are shifted to larger potential values on the forward scan and to lower potential values on the backward scan. This over-potential is due to the resistance of about 1 MΩ along the microchannel, which means that for passing 0.4 μA, the iR drop is about 0.4 volt. This is indeed what is measured as a deformation signal. When the electrically conductive means (7) is added to the chip and not connected or connected to the potentiostat as a counter electrode by its pad (12), this iR drop is almost zero, as shown in FIG. 10 where currents up to 1 μA can pass through the microstructure (2) without voltammogram deformation.

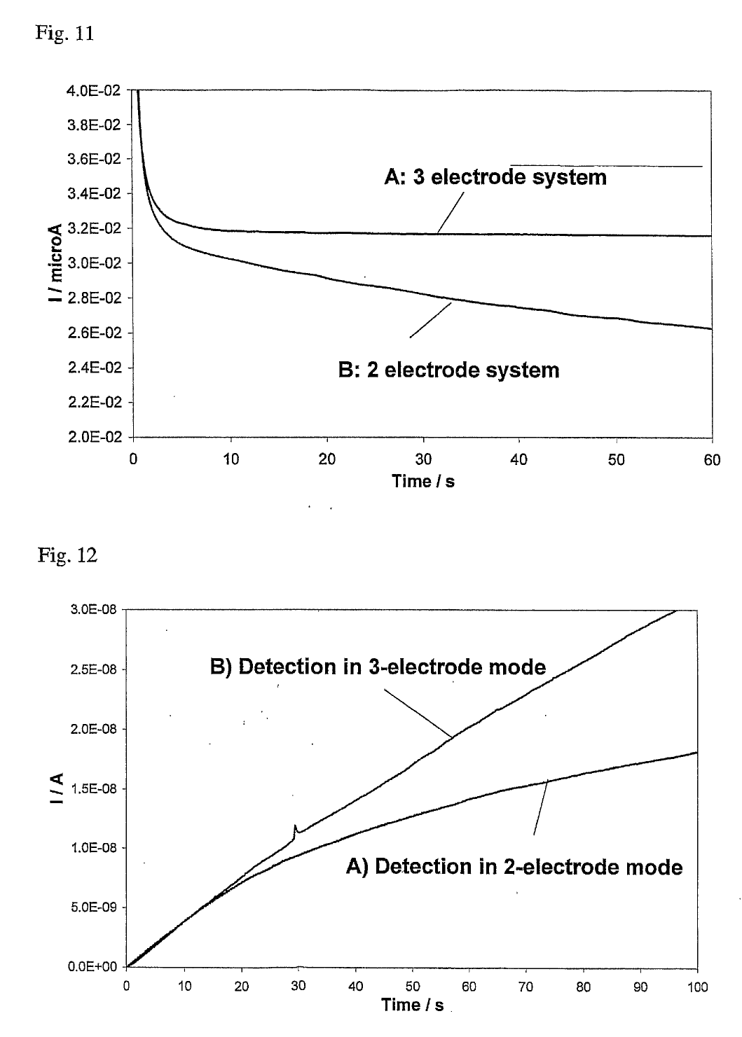

In one embodiment of this invention, the conductive means (7) can be connected as the counter electrode or not, depending on the counter reaction that takes place. For instance, when the counter reaction may pollute the working electrode (4), it may be better to make this reaction occur outside the microstructure (2) at the pseudo-reference electrode (6) placed in contact with the solution at the microstructure inlet and/or outlet, with a potentiostat working in 2-electrode mode. The system is still working satisfactorily, and the electrically conductive means (7) still avoids large iR drops, even though it is not connected. In the presence of a reversible or pseudo-reversible reaction the connection of the electrically conductive means (7) as a counter electrode enables a regeneration of at least some of the molecules detected at the working electode (4) as shown in FIG. 11. When the conductive means (7) is not connected (which corresponds to a detection system in a 2-electrode mode), the voltage applied at the the working electrode array (4) allows oxidation of the ferrocene carboxylic acid molecule, so that the measured amperometric current drops continuously, because the concentration of reduced ferrocene molecules decreases rapidly in the microstructure (2) and hence in the volume around the working electrode which is probed on the time scale of the amperometric measurement. In another example, when the same microfluidic device (1) is connected in a 3-electrode mode with the electrically conductive means (7) as the counter electrode and a reference electrode placed at the microstructure inlet or outlet (namely a Ag/AgCl ink dot deposited on a gold-coated copper pad), the molecules that have been oxidised at the working electrodes can then be reduced on the counter electrode, so that a recycling process is established which allows regeneration of the oxidised molecules back into ferrocene carboxylic acid. This regeneration process rapidly reaches an equilibrium state, so that a steady state current is measured.

In some cases, for instance when an enzymatic reaction takes place in a microstructure, the concentration of the analyte to detect can increase with time, so that it can reach a concentration that would generate a current intensity which is difficult to pass through the chip without iR drop. As a consequence, the potential-current response shifts and the current at a given potential reaches a plateau due to ohmic (iR) drop. This case is shown in FIG. 12 for the detection of alkaline phosphatase (ALP) by means of p-aminophenol phosphate hydrolysed and detected at 200 mV. When the microfluidic device (1) has no electrically conductive means (7), a plateau is reached after few seconds of detection. In contrast, the same reaction gives a more linear shape with a microfluidic device (1) comprising an electrically conductive means (7) according to the invention. This feature is therefore of prime interest for the optimisation of e.g. biosensor devices with electrochemical detection.

In a further embodiment, this enzymatic reaction can be detected with a microfluidic device (1) containing a conductive means (7) with and without being connected as counter electrode. In this case, the product of the enzyme hydrolysis (here p-aminophenol) can be oxidised into quinone imide. This oxidation reaction is reversible, so that quinone imide can be reduced back into p-aminophenol at a counter-electrode or by inverting the potential applied at the working electrode(s) so as to regenerate the analyte molecules to detect. In the case where the conductive means is connected as the counter electrode, the reduction of quinone imide is done at the counter electrode and the concentration of p-aminophenol is larger, thereby giving a larger current response during the reaction. This case is shown in FIG. 12.

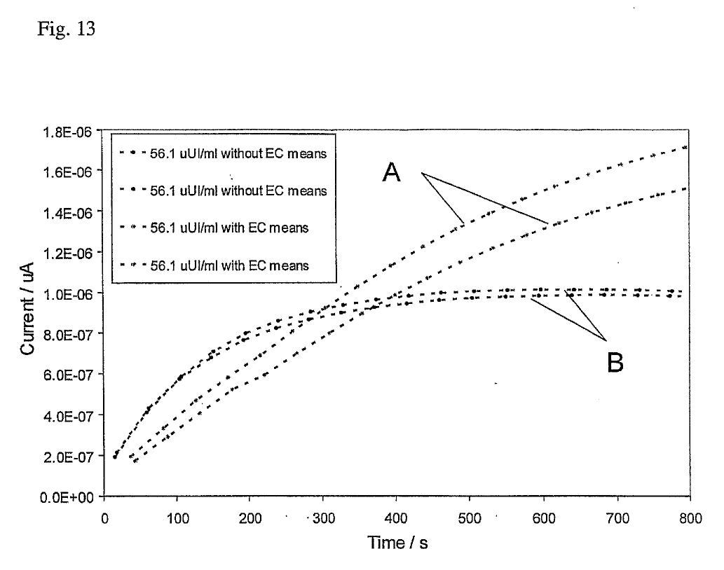

As another example of applications of the device of the present invention, FIG. 13 shows the time evolution of the current obtained for the amperometric detection of the thyroid stimulating hormone (TSH) by enzyme linked immunosorbent assay (Elisa) in plasma in microfluidic sensor devices with (A) and without (B) integrated electrically conductive means, both microfluidic devices comprising microchannels having sensibly the same geometrical characteristics (namely ˜1 cm in length and ˜50 μm in depth) and an Ag/AgCl electrode placed at the inlet of the microchannel, similar to that shown in FIG. 7 but with a series of 48 integrated gold working electrodes produced in a gold-coated copper support. When present, the integrated electrically conductive means is connected as counter-electrode, and the Ag/AgCl is used as reference electrode. In the absence of the electrically conductive means, the Ag/AgCl electrode is used as pseudo-reference electrode.

In order to determine TSH concentration in plasma, the microfluidic devices is first coated with anti-TSH and blocked against non-specific adsorption using a calf serum solution. After incubation of TSH samples having a known concentration of 56.1 μUI/mL, the microchannels are filled with a solution of anti-TSH conjugate labelled with alkaline phosphatase (ALP). Detection is then performed by amperometric measurements at different times upon application of 200 mV vs Ag/AgCl and with p-aminophenyl phosphate (PAPP) as enzymatic substrate. The assay is repeated twice with both types of microchips, and the time evolution of the measured current is shown in FIG. 13. When the chip does not comprise any electrically conductive means (curves B), the current reaches a plateau level, meaning that a combination between depletion of the product of the enzymatic reaction and resistance along the microchannel (iR drop) limits the signal increase. In the case of the chips with an integrated electrically conductive means acting as counter-electrode (curves A), the measured charge is not limited and continuously increases with time, showing that there is almost no iR drop and that part of the oxidised product (namely quinone imide in the present case) is regenerated into p-aminophenol.

It should be stressed here that the size of the electrodes is not exactly the same in the devices used to generate the data shown in FIGS. 13A and 13B. Indeed, the device comprising an electrically conductive means along the microchannel length had smaller working electrodes than that without electrically conductive means (diameter of about 30 μm instead of about 50 μm). This explains why the measured current is a bit smaller in FIG. 13A than in FIG. 13B in the first part of the measurements. If both systems had absolutely the same geometrical characteristics and dimensions (including electrode size), the current response should be approximately identical in this first part of measurements. As the analyte concentration increases with time in these experiments, the measured current saturates after few minutes in FIG. 13B because of the absence of electrically conductive means, which induces increasing iR drop and induces a potential shift which limits the measurable current at high concentrations. In such amperometric measurement, the applied potential is indeed fixed at a given value in the potentiostat, so that the voltage effectively applied between the working and pseudo-reference electrodes is actually decreased by the value of the iR drop. In conventional electrochemical systems, this decrease of potential should be compensated by application of an over-potential, which is difficult to implement in a sensor (notably because the additional potential to apply depends on the nature of the solution, on the geometry of the device and on the analyte concentration which can even evolve with time as in the present example). The integration of the electrically conductive means enables a minimised iR drop and hence does not require instrumentation for compensating possible shift of applied potential with large current. This is indeed confirmed in FIG. 13A, which clearly shows that the measured current does always increase, because the global resistance of the microsystem is minimised, so that the iR drop is always small, even with large currents.

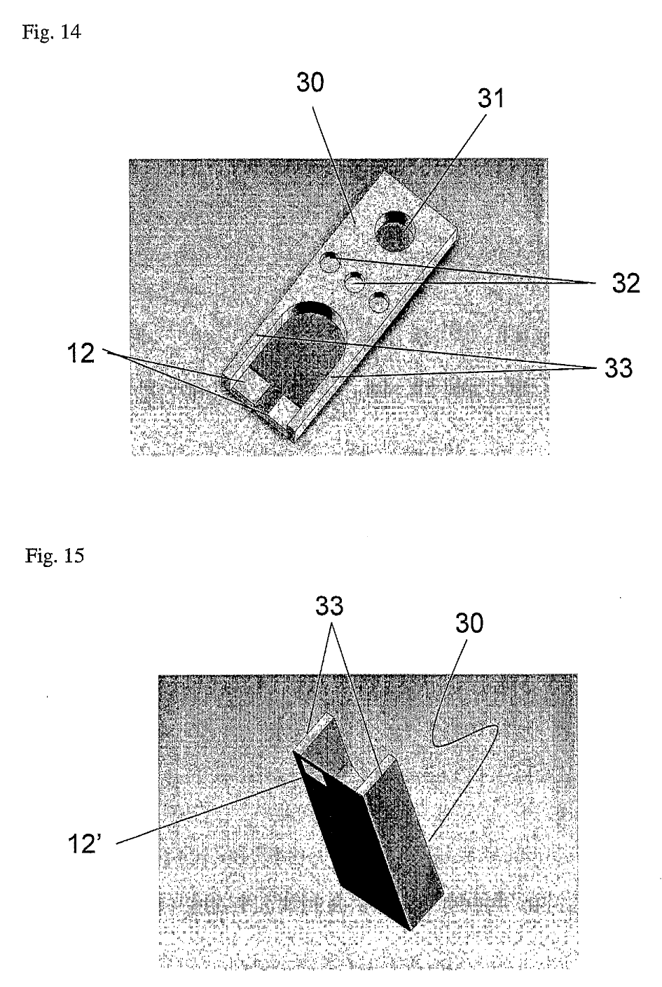

In a further embodiment, the microfluidic device of the present invention comprises a top layer (10), preferably composed of a polymer, in order to solidify and stabilise the entire assembly. This top layer (30) is illustrated in FIGS. 14 and 15 which show the technical drawings of the corresponding cartridge, and this top layer may comprise different components, serving as different functions, such as:
a) an entrance (or inlet) reservoir made of a hole (31) in the present case and which is placed in such a way that the entrance of the microchannel is at the bottom of the reservoir wall, such as to enable efficient reservoir emptying,
b) other reservoirs (32) that enable storage of dried or wet reagents or solutions,
c) position guides (33) in order to handle the microfluidic device and place it easily in contact with an instrument interface (for fluidic and/or electrical connection for instance); these position guides still leave space for the conductive track (12) connection on the top and on the back side of the microfluidic device (12′).

The microfluidic device of the present invention can advantageously be used in analytical applications, such as but not limited to electrochemical sensors, sampling by ion spray ionisation or as a detector in capillary electrophoresis.

1. An electrochemical microfluidic device having a two- or three-electrode system for producing a detectable signal for determining the presence or amount of an analyte in a sample, said system comprising a pseudo-reference electrode and at least one working electrode in the two-electrode configuration or a reference electrode, a counter-electrode and at least one working electrode in the three-electrode configuration, said device comprising at least one microstructure in a solid substrate, said microstructure having said at least one electrode or array of working electrodes integrated in at least one wall portion of said microstructure and an electrically conductive means in addition to said two- or three-electrode system adapted to form a path of reduced electrical resistance in said microstructure between said at least one working electrode or working electrode array and the pseudo-reference of said two-electrode system or, respectively, between said at least one working electrode or working electrode array and the counter-electrode or the reference electrode of said three-electrode system.

2. An electrochemical microfluidic device according to claim 1, wherein said electrically conductive means is an integral part of at least one wall portion of said microstructure.

3-38. (canceled)

39. A method of fabricating an electrochemical microfluidic device comprising a two- or three-electrode system for producing a detectable signal for determining the presence or amount of an analyte in a sample, said system comprising a pseudo-reference electrode and at least one working electrode in the two-electrode configuration or a reference electrode, a counter-electrode and at least one working electrode in the three-electrode configuration, said method comprising the following steps in any order: forming at least one microstructure in a solid substrate, forming at least one working electrode or working electrode array integrated in at least one wall portion of said microstructure and forming an electrically conductive means in addition to said two- or three-electrode system adapted to reduce the form a path of reduced electrical resistance in said microstructure between said at least one working electrode and the pseudo-reference electrode of said two-electrode system or, respectively, between said at least one working electrode and the counter-electrode or the reference electrode of said three-electrode system.

40. A method of fabricating an electrochemical microfluidic device according to claim 39, wherein said electrically conductive means is formed as an integral part of at least one wall portion of said microstructure.

41-49. (canceled)

50. A method of fabricating an electrochemical microfluidic device according to claim 39, wherein said electrically conductive means forms a frieze of conducting material surrounding at least one portion of said microstructure.

51. A method of fabricating an electrochemical microfluidic device according to claim 39, wherein a cover layer is added to said electrochemical microfluidic device in order to cover said microstructure.

52. A method of fabricating an electrochemical microfluidic device according to claim 51, wherein said cover layer is added to said solid substrate and/or said electrically conductive means by lamination, adhesive addition, pressure application, and/or bonding after chemical activation or treatment by exposure to a plasma.

53. A method of fabricating an electrochemical microfluidic device according to claim 39, wherein said microfluidic device is fabricated by embossing, polymer casting, injection moulding, laser ablation, chemical etching, physical etching, plasma etching, UV Liga, assembly of a plurality of layers, or any combination thereof.

54. A method of fabricating an electrochemical microfluidic device according to claim 39, wherein said electrically conductive means comprises at least one through-hole serving as a mask to manufacture the microstructure in the substrate supporting the microstructure.

55. A method according to claim 54, wherein said mask is machined in a metal, e.g. copper, and/or coated with an inert metal, e.g. gold or platinum, after the step of fabricating said microstructure, so as to provide the desired shape, size and electrochemical properties to any one of said electrically conductive means, reference electrode, pseudo-reference electrode, counter-electrode and reference electrode.

56. A method of fabricating an electrochemical microfluidic device according to claim 54, wherein the manufacture of said microstructure is by isotropic etching, so that under-etching around the mask enables the electrically conductive means to be in contact with the solution present in said electrochemical microfluidic device.

57. An electrochemical microfluidic device according to claim 1, wherein said electrically conductive means forms a frieze of conducting material surrounding at least one portion of said microstructure.

58. An electrochemical microfluidic device according to claim 1, wherein said electrically conductive means has no connection to an external electrical meter such as a potentiostat or a power supply.

59. An electrochemical microfluidic device according to claim 1, wherein said integrated working electrode or working electrode array is produced on one side of said solid substrate and wherein said electrically conductive means is produced on the other side of said solid substrate and wherein said electrically conductive means is produced on the other side of said solid substrate in such a manner that the integrated working electrode or working electrode array and the electrically conductive means are located substantially in front of each other but on the opposite sides of the microstructure.

60. An electrochemical microfluidic device according to claim 1, further comprising a cover layer to cover said microstructure.

61. An electrochemical microfluidic device according to claim 60, wherein said cover layer itself includes at least one microstructure.

62. An electrochemical microfluidic device according to claim 1, wherein said electrochemical microfluidic device is a multilayer body composed at least of: said solid substrate with said microstructure having said at least one integrated working electrode; said electrically conductive means forming at least one wall portion of said microstructure; a cover layer above said electrically conductive means and above at least one portion of said solid substrate adapted to close said microstructure; and inlet and outlet means for permitting said sample to enter and, respectively, exit said microstructure.

63. An electrochemical microfluidic device according to any claim 1, further comprising a supplementary rigid layer, said supplementary rigid layer comprising one or a plurality of through-holes and/or cavities each serving as a solution reservoir at a microstructure inlet and/or outlet and/or serving as a reagent reservoir.

64. An electrochemical microfluidic device according to claim 63, wherein said reservoir comprises at least one dried and/or immobilised reagent.

65. An electrochemical microfluidic device according to claim 64, wherein said reagent is dried and/or immobilised on any one of a wall of said reservoir, a membrane, a filter and/or beads.

66. An electrochemical microfluidic device according to claim 1, wherein at least one inlet and/or outlet of said microstructure is in contact with said electrically conductive means.

67. An electrochemical microfluidic device according to claim 1, wherein the pseudo-reference or the reference electrode of the two- or, respectively, three-electrode system is an integral part of the microfluidic device.

68. An electrochemical microfluidic device according to claim 67, wherein said reference electrode or pseudo-reference electrode is integrated in said microstructure.

69. An electrochemical microfluidic device according to claim 67, wherein the pseudo-reference electrode or the reference electrode of said two- or, respectively, three-electrode system is located outside said microstructure but to be in contact with the solution to analyze.

70. An electrochemical microfluidic device according to claim 1, wherein said reference electrode or said pseudo-reference electrode is a metal and/or a conductive ink placed on a metallic pad.

71. An electrochemical microfluidic device according to claim 1, wherein said microfluidic device comprises an electrically conductive track and/or pad enabling connection of at least one of said integrated working electrode or working electrode array, of said counter-electrode and/or of said reference or pseudo-reference electrode to one or a plurality of external instruments.

72. An electrochemical microfluidic device according to claim 1, wherein any one of said integrated working electrode or working electrode array, of said electrically conductive means and/or of said counter-electrode is made of a conducting ink, or of a metal, e.g. copper or nickel coated with an electrochemically inert metal, e.g. gold or platinum.

73. An electrochemical microfluidic device according to claim 1, wherein said microstructure comprises at least one chemical and/or biological material.

74. An electrochemical microfluidic device according to claim 73, wherein said chemical or biological material is at least one of a carboxylic, an amino, a thiol or a phenolic group, an antigen, an antibody, an enzyme, an affinity agent, DNA, a DNA strain, an oligonucleotide, a peptide, a hapten, a cell, a bacteria or a virus.

75. An electrochemical microfluidic device according to claim 73, wherein said chemical or biological material is immobilised on at least one wall portion of said microstructure, preferably by at least one of physisorption, chemisorption, covalent binding and ionic binding.

76. An electrochemical microfluidic device according to claim 1, characterized in that the device is formed such that at least one portion of said microstructure can receive a medium, said medium being a fluid, a solid, a sol-gel or a gel.

77. An electrochemical microfluidic device according to claim 76, wherein said medium is functionalised with at least one chemical or a biological entity.

78. An electrochemical microfluidic device according to claim 77, wherein said medium comprises beads, a filter and/or a membrane.

79. An electrochemical microfluidic device according to claim 1, characterized in that said microfluidic device is formed like any one of an electrospray tip, a nanospray tip, a sensor tip and a fluid dispenser.

80. An electrochemical microfluidic device according to claim 1, characterized in that said electrochemical microfluidic device is formed in a manner that chemical and/or biological assays, such as e.g. physico-chemical compound characterisation tests, immunological assays, affinity assays, dosage of ions, enzymatic assays, oligonucleotide assays, DNA tests or cellular assays can be performed.

81. A method comprising the steps of: using said electrochemical microfluidic device according to claim 1; and performing chemical and/or biological reactions preferably in solution and particularly in connection with synthesis, or performing chemical and/or biological analysis particularly in connection with chemical and/or biological assays, physico-chemical compound characterisation tests, immunological assays, affinity assays, dosage of ions, enzymatic assays, oligonucleotide assays, DNA tests or cellular assays, separation techniques, electrophoresis, chromatography, or mass spectrometry.
